(19) United States
(12) Patent Application Publication
(10) Pub. No.: US 2020/0300374 A1
(43) Pub. Date: Sep. 24, 2020

(54) BALL MECHANISM-INCREASED / ENHANCED INITIAL ROTATION-OPENING OF BALL

(71) Applicant: Halliburton Energy Services, Inc., Houston, TX (US)

(72) Inventors: Mark John Milne, Arbroath (GB); Peter Derek Walter Inglis, Carrollton, TX (US)

(21) Appl. No.: 16/086,153

(22) PCT Filed: May 25, 2016
(86) PCT No.: PCT/US2016/034170

§ 371 Date: Sep. 18, 2018

(51) Int. Cl. F16K 5/06; F16K 5/20; E21B 34/06

(52) U.S. Cl. CPC F16K 5/0647; E21B 2200/04; E21B 34/06; F16K 5/204

(57) ABSTRACT

A ball valve including a valve body having inlet and outlet flow passageways connected by a valve chamber; a ball valve member mounted in the valve chamber for selective rotation between valve open and valve closed positions to control flow through the valve, the ball valve member including at least one pivot pin and a mount for a control arm; and at least one control arm including a slot configured to accept a control arm bushing, the pivot pin, and combinations thereof, wherein the control arm is mounted to the ball valve member, and wherein upon application of an axial load on the control arm to the open or close the ball valve, the axial load on the control arm is transferred to at least one of a control arm bushing, the pivot pin on the ball valve member, and combinations thereof.

### BACKGROUND

A ball valve is a type of valve that uses a spherical ball as a closure mechanism. The ball has a hole therethrough that is aligned with the direction of flow when the valve is opened and misaligned with the direction of flow when the valve is closed. Ball valves have many applications in well tools for use downhole in a wellbore, for example, as formation tester valves, safety valves, and in other downhole applications. Many of these well tool applications use a ball valve because ball valves can have large through bore for passage of tools, tubing strings, and flow, yet also be compactly arranged, for example, having a cylindrical outer profile that corresponds to the cylindrical outer profile of the remainder of the string carrying the ball valve into the well bore and presenting few or no protrusions to hang up on the interior of the well.

A ball valve contains a ball opening and closing mechanism. As seen in FIG. 1, the ball mechanism 100 includes, in simple terms with only one of each element shown, two control arms 110 with pivot pins 112, two ball arm bushings 114, and a rotating ball member 116 with milled slots 118 on either side to accommodate the pivot pin 112 on the control arm 110 and the bushing 114. The ball member 116 includes mounting pivot pins 120 to mount the control arm 110 in the mounting slot 122.

When the ball is in the “closed” position, it seals against a seat and does not allow fluid to pass through it. When the ball is in the “open” position (i.e. rotated through an angle of 90°), it allows fluid to pass through it.

Debris may be present upstream of the closed valve. As the valve opens the debris may cause problems with the rotation of the ball as well as the interior cavity as the debris rushes into the newly created void. Therefore, there exists a need for a ball valve that can better handle the influx of debris.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIG. 1 is a depiction of a deconstructed ball mechanism according to the prior art.

FIG. 2 is a depiction of a deconstructed ball mechanism according to embodiments of the present invention.

FIGS. 3A,B are overhead cross-sectional views of a ball valve in a closed and open position according to the prior art.

FIGS. 4A,B are overhead cross-sectional views of a ball valve in a closed and open position according to embodiments of the present invention.

FIG. 5 is an overhead cross-sectional view of a ball valve in a slightly open position according to the prior art.

FIG. 6 is overhead cross-sectional view of a ball valve in a slightly open position according to embodiments of the present invention.

FIG. 7 is a side cross-sectional view of a well system with an embodiment of a ball valve of the present invention.

### DETAILED DESCRIPTION

During the “opening” function of the ball mechanism, there is a volume just above the closed ball mechanism that may be heavily laden with compacted debris that valve parts must move through as the ball mechanism is opened. This movement may cause further compaction of the debris, potentially reducing the ability of the ball mechanism to open. As the ball mechanism begins to rotate and open, this progressively opens up and creates a void for the compacted debris to enter, thus increasing the ball mechanism's ability to open.

The ball mechanism design of the disclosure, described below, increases and enhances the initial rotation of the ball, assuming the same initial linear/axial travel of the control arms, thus creating a void for the debris to enter much earlier in the opening of the ball mechanism member. Also, the ball mechanism member may “crack open/come off seat” earlier, thus encouraging flow to begin sooner, potentially washing through the debris, and enhancing the debris tolerance of the valve.

In an embodiment, a ball valve comprises a valve body having inlet and outlet flow passageways connected by a valve chamber; a ball valve member mounted in said valve chamber for selective rotation between valve open and valve closed positions to control flow through the valve, the ball valve member comprising at least one pivot pin and at least one mount for a control arm; and at least one control arm comprising at least one slot configured to accept at least one of a control arm bushing, the at least one pivot pin, and combinations thereof, wherein the at least one control arm is mounted to the ball valve member. In one embodiment, upon application of an axial load on the at least one control arm to the open or close the ball valve, the axial load on the at least one control arm is transferred to at least one of a control arm bushing, the at least one pivot pin on the ball valve member, and combinations thereof. The ball valve may further comprise a seat in the valve body around each of said passageways adjacent to the ball valve member. In an embodiment, the ball valve further comprises at least one control arm bushing mounted on said at least one pivot pin. The at least one control arm bushing may be a square or rectangular bushing machined to slide in the at least one slot of the at least one control arm. In another embodiment, the ball valve further comprises a second control arm with a slot, a second pivot pin, and a second mount on the ball valve member for the second control arm. The second control arm and second pivot pin may be located on the opposite side of the ball valve member from the at least one pivot pin and at least one control arm. The at least one slot in the at least one control arm may be milled. The at least one pivot pin may be circular in shape. In exemplary embodiments, the ball valve has increased initial rotation of the ball valve member for the same axial travel of the at least one control arm compared to a ball valve where the at least one pivot pin is on the at least one control arm, the at least one slot is on the ball valve member, and the at least one pivot pin slides in the at least one slot of the ball valve member. In some embodiments, the mount for the at least one control arm on the ball valve member comprises at least one mounting pivot pin around which the at least one control arm pivots. The at least one control arm may comprise a second slot for receiving the at least one mounting pivot pin of the ball valve member.

In another embodiment, a ball mechanism comprises a ball valve member having inlet and outlet flow passageways, the ball valve member comprising at least one pivot pin and a mount for a control arm, wherein the ball valve member controls flow through the passageways upon selective rotation between open passageway and closed passageway positions; and at least one control arm comprising a slot configured to accept at least one of a control arm bushing, the at least one pivot pin, and combinations thereof, wherein the at least one control arm is mounted to the ball valve member. In one embodiment, upon application of an axial load on the at least one control arm to rotate the ball valve member, the axial load on the at least one control arm is transferred to at least one of a control arm bushing, the at least one pivot pin on the ball valve member, and combinations thereof. In an embodiment, the ball mechanism may further comprise a valve body having inlet and outlet flow passageways connected by a valve chamber, wherein the ball valve member is mounted in the valve chamber. In an embodiment, the ball mechanism further comprises at least one control arm bushing mounted on said at least one pivot pin. The at least one control arm bushing may be a square or rectangular bushing machined to slide in the slot of the at least one control arm. In another embodiment, the ball mechanism further comprises a second control arm with a slot, a second pivot pin, and a second mount on the ball valve member for the second control arm. The second control arm and second pivot pin may be located on the opposite side of the ball valve member from the at least one pivot pin and at least one control arm. The at least one slot in the control arm may be milled. The at least one pivot pin may be circular in shape. In exemplary embodiments, the ball valve has increased initial rotation of the ball valve member for the same axial travel of the control arm compared to a ball valve where the pivot pin is on the control arm, the slot is on the ball valve member, and the pivot pin slides in the slot of the ball valve member. In some embodiments, the mount for the at least one control arm on the ball valve member comprises at least one mounting pivot pin around which the at least one control arm pivots. The at least one control arm may comprise a second slot for receiving the at least one mounting pivot pin of the ball valve member.

In an embodiment, a method for opening or closing a ball valve comprises applying an axial load on the at least one control arm of a ball valve comprising a valve body having inlet and outlet flow passageways connected by a valve chamber; a ball valve member mounted in said valve chamber for selective rotation between valve open and valve closed positions to control flow through the valve, the ball valve member comprising at least one pivot pin and at least one mount for at least one control arm; and at least one control arm comprising at least one slot configured to accept at least one of a control arm bushing, the at least one pivot pin, and combinations thereof, wherein the at least one control arm is mounted to the ball valve member. In one embodiment, upon application of an axial load on the at least one control arm to open or close the ball valve, the axial load on the at least one control arm is transferred to at least one of at least one control arm bushing, the at least one pivot pin on the ball valve member, and combinations thereof. In an embodiment, the method further comprises at least one control arm bushing mounted on said at least one pivot pin. The at least one control arm bushing may be a square or rectangular bushing machined to slide in the at least one slot of the at least one control arm. In another embodiment, the method further comprises a second control arm with a slot, a second pivot pin, and a second mount on the ball valve member for the second control arm. The second control arm and second pivot pin may be located on the opposite side of the ball valve member from the at least one pivot pin and at least one control arm. The at least one slot in the at least one control arm may be milled. The at least one pivot pin may be circular in shape. In exemplary embodiments, the ball valve has increased initial rotation of the ball valve member for the same axial travel of the at least one control arm compared to a ball valve where the at least one pivot pin is on the at least one control arm, the at least one slot is on the ball valve member, and the at least one pivot pin slides in the at least one slot of the ball valve member. In some embodiments, the mount for the at least one control arm on the ball valve member comprises at least one mounting pivot pin around which the at least one control arm pivots. The at least one control arm may comprise a second slot for receiving the at least one mounting pivot pin of the ball valve member.

Existing Ball Mechanism Design

The existing ball valve actuation “opening” system according to the prior art involves creating an axial load, produced either by a hydraulic actuation pressure acting on a piston area or a combination of this and an initially compressed pair of wave springs, being transferred to two control arms on either side of the ball that are limited to axial travel. This creates a 90° rotation of the ball from the “closed” to the “open” position. The control arms each have a circular pivot pin, onto which are assembled square or rectangular shaped bushings. On either side of the ball there are milled slots for the bushings to slide up and down within. The ball is rotated back through 90° to the “closed” position mechanically. The axial opening load is transferred to the control arms and control arm pivot pins, onto the square or rectangular bushings, and onto the ball via the milled slots, to create a 90° rotation of the ball.

New Ball Mechanism Design

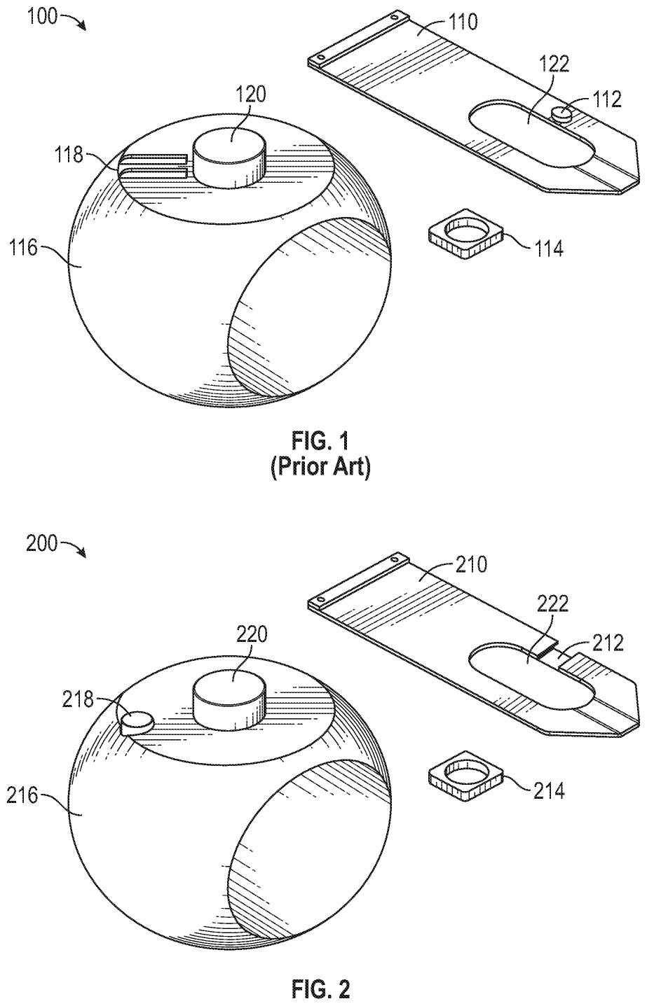

As seen in FIG. 2, an embodiment of the ball mechanism 200 of the disclosure includes, in simple terms with only one of each element shown, control arms 210 with slots 212, two ball arm bushings 214, and a rotating ball member 216 with pivot pins 218 on either side that are accommodated by the slots 212 on the control arm 210 and the bushing 214. The ball member 216 includes mounting pivot pins 220 to mount the control arm 210 in the mounting slot 222.

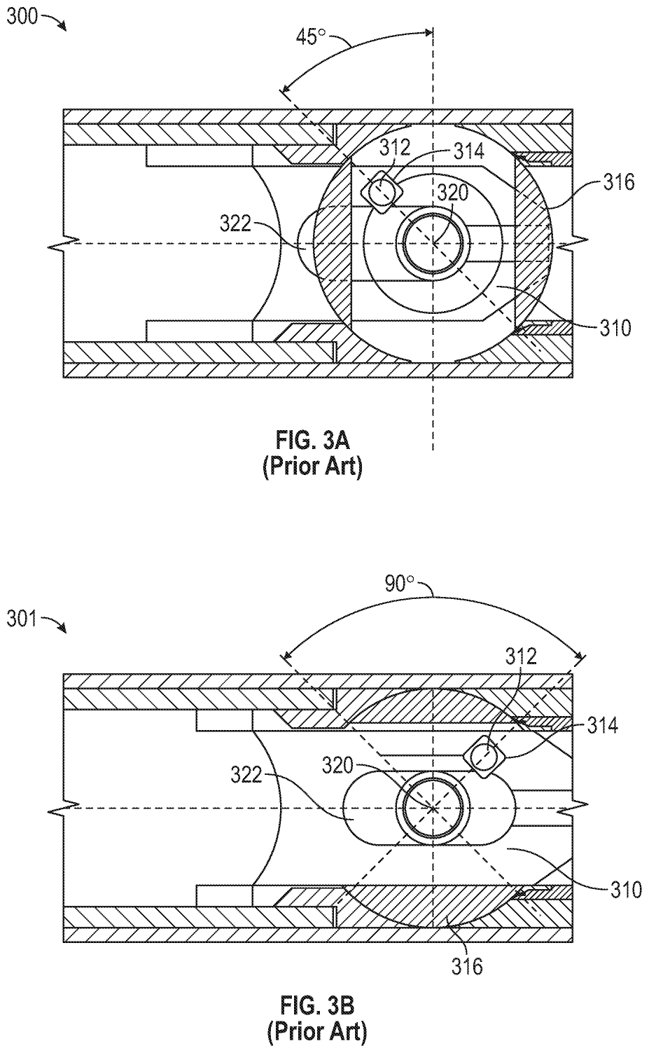

The ball mechanism may be housed in a valve body. Valve bodies are shown in FIGS. 3-6, and may be made up of multiple parts for convenience of construction, and in other instances, may be made of fewer or more parts. The ends of the valve body may be configured to couple to other components of a completion string (e.g., threadingly and/or otherwise). The ball member rotates about an axis transverse to the longitudinal axis of the valve body. The valve is open when the central passage of the ball member aligns with and coincides with the central passage of the valve body. The valve is closed when the central passage of the ball member does not coincide with, and seals against passage of fluid and pressure through the central passage of the valve body.

The pivot pin 218 may be any shape that can slide in slot 212 on control arm 210 and/or accept a bushing 214. In an embodiment, the pivot pin 218 is circular. The bushing 214 may be any shape that fits onto the pivot pin 218 and slides in the slot 212 on the control arm 210. In an embodiment, the bushing 214 is square or rectangular in shape.

In an embodiment, the “load path” to open the rotating ball member begins with an axial load being produced, for example by pressure or springs, and transferred to the control arms and slots, which are limited to linear/axial travel only. From the slots, the load is transferred onto the bushings located and sliding within the slots, and then onto the pivot pins on either side of the rotating ball member. The load and resulting motion creates the 90° rotation of the rotating ball member required to open the path for flow through the ball valve.

Start and End Positions

As seen in FIG. 3A,B, the existing style of ball mechanism 300 includes a control arm 310 with a pivot pin 312, a ball arm bushing 314, and a rotating ball member 316 with a milled slot 318 to accommodate the pivot pin 312 on the control arm 310 and the bushing 314. The ball member 316 includes a mounting pivot pin 320 to mount the control arm 310 in the mounting slot 322. With this configuration of pivot pins 320 and slots 318, and due to the restricted “axial-only” linear travel of the control arm 310, the “start/closed” and “end/open” positions must be “in-line” and must conform to a “45°-90°-45°” configuration. FIG. 3A demonstrates the closed position 300 of the existing valve with a starting position of 45°. FIG. 3B demonstrates the open position 301 of the existing valve in the 90° orientation.

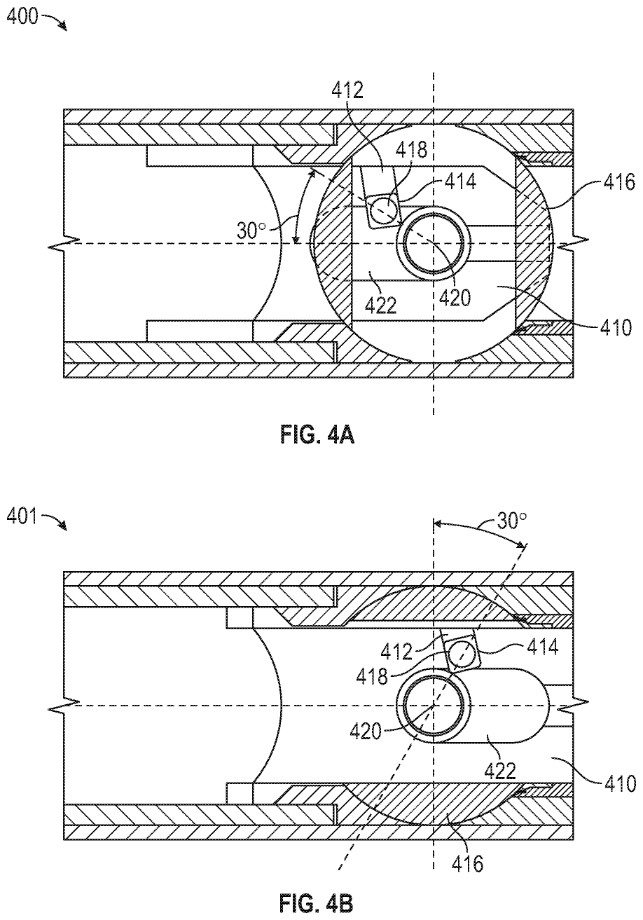

The ball valves and rotating ball members according to this disclosure may provide more flexibility to the “start/closed” and “end/open” positions of the pivot pins. As seen in FIGS. 4A,B, an embodiment of the ball mechanism 400 of the disclosure includes, in simple terms with only one of each element shown, control arms 410 with slots 412, two ball arm bushings 414, and a rotating ball member 416 with pivot pins 418 on either side that are accommodated by the slots 412 on the control arm 410 and the bushing 414. The ball member 416 includes mounting pivot pins 420 to mount the control arm 410 in the mounting slot 422. Positioning the “start/closed” position of the pivot pins 418, which are now part of the rotating ball member 416, at an angle less than the current design of 45°, creates an increased/enhanced initial rotation of the rotating ball member 416, assuming the same initial axial travel of the existing design. As an example, if the “start/closed” position 400 is at 30°, as demonstrated in FIG. 4A, the resulting “end/open” position 401 will be being at 60°, as seen in FIG. 4B. This is a “30°-90°-60°” configuration. Note that the rotating ball mechanism 416 still requires a total rotation of 90° from “start/closed” to “end/open”.

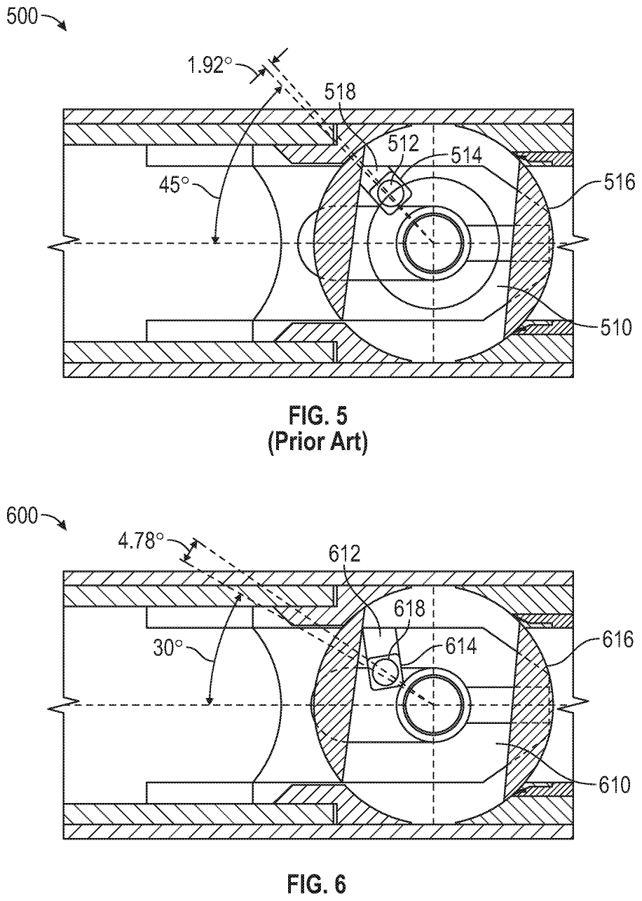

In an embodiment, the increased/enhanced initial rotation of the ball valve of this disclosure is demonstrated in FIGS. 5 and 6. For an existing style ball valve 500, an axial load is applied to the control arms 510 and control arm pivot pins 512. The load transfers onto the square or rectangular bushings 514, and onto the ball member 516 via the milled slots 518, to create a 90° rotation of the ball. For an axial travel distance of 0.100 inches, the existing valve, starting at 45°, may have 1.92° rotation as seen in FIG. 5.

In an embodiment illustrated in FIG. 6, the ball valve 600 according to this disclosure has a load transferred to the control arm 610 and slot 612, which are limited to linear/axial travel only. From the slot 612, the load is transferred onto the bushing 614 located and sliding within the slot 612. The load then transfers onto the pivot pin 618 on the rotating ball member 616. The ball valve 600 according to this disclosure, starting at 30°, may have a 4.78° rotation as demonstrated in FIG. 6. This 4.78° initial opening is for 0.100 inches of axial travel. As noted above, the prior art design only produced a 1.92° initial opening with 0.100 inches of axial travel.

One of skill in the art will realize that the ball valves according to embodiments of this disclosure have more flexibility in the design of the valve and operation of the valve. One of the advantages is an increased and enhanced initial rotation of the ball member. This may make the ball valve more debris tolerant and useful in oil wells with more challenging conditions.

Use in Wellbore

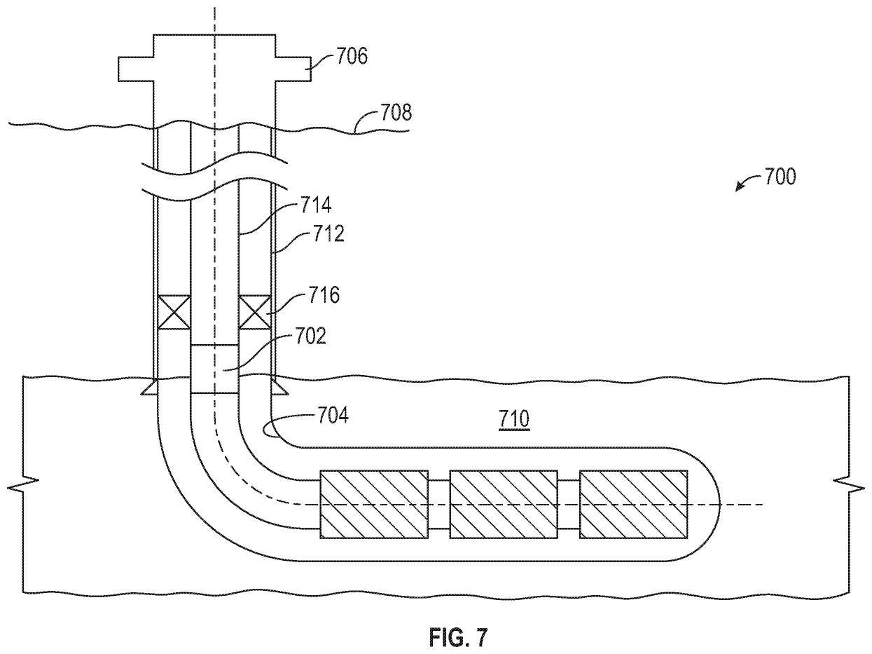

FIG. 7 is a side cross-sectional view of a well system 700 with an example ball valve 702 constructed in accordance with the concepts herein. The well system 700 is provided for convenience of reference only, and it should be appreciated that the concepts herein are applicable to a number of different configurations of well systems. As shown, the well system 700 includes a substantially cylindrical wellbore 704 that extends from well head 706 at a terranean surface 708 through one or more subterranean zones of interest 710. In FIG. 7, the wellbore 704 extends substantially vertically from the surface 708 and deviates to horizontal in the subterranean zone 710. However, in other instances, the wellbore 704 can be of another configuration, for example, entirely substantially vertical or slanted, it can deviate in another manner than horizontal, it can be a multi-lateral, and/or it can be of another configuration.

The wellbore 704 is lined with a casing 712, constructed of one or more lengths of tubing, that extends from the well head 706 at the surface 708, downhole, toward the bottom of the well 704. The casing 712 provides radial support to the wellbore 704 and seals against unwanted communication of fluids between the wellbore 704 and surrounding formations. Here, the casing 712 ceases at the subterranean zone 710 and the remainder of the wellbore 704 is an open hole, i.e., uncased. In other instances, the casing 712 can extend to the bottom of the wellbore 704 or can be provided in another configuration.

A completion string 714 of tubing and other components is coupled to the well head 706 and extends, through the wellbore 704, downhole, into the subterranean zone 710. The completion string 714 is the tubing that is used, once the well is brought onto production, to produce fluids from and inject fluids into the subterranean zone 710. Prior to bringing the well onto production, the completion string is used to perform the final steps in constructing the well. The completion string 714 is shown with a packer 716 above the subterranean zone 710 that seals the annulus between the completing string 714 and casing 712, and directs fluids to flow through the completion string 714 rather than the annulus.

The example valve 702 is provided in the completion string 714 below the packer 716. The valve 702 when open, allows passage of fluid and communication of pressure through the completion string 714. When closed, the valve 702 seals against passage of fluid and communication of pressure between the lower portion of the completion string 714 below the valve 702 and the upper portion of the completion string 714. For remote operation, the valve 702 has a remote actuator assembly that responds to a signal (e.g., a hydraulic, electric, and/or other signal) to operate the valve. The signal can be generated remote from the valve 702, for example at the surface.

In the depicted example, the valve 702 is shown as a fluid isolation valve that is run into the wellbore 704 open, mechanically closed with a shifting tool and then eventually re-opened in response to a remote signal. The valve 702, thus allows an operator to fluidically isolate the subterranean zone 710, for example, while an upper portion of the completion string 714 is being constructed, while subterranean zones above the valve 702 are being produced (e.g., in a multi-lateral well), and for other reasons. The concepts herein, however, are applicable to other configurations of valves. For example, the valve 702 could be configured as a safety valve. A safety valve is typically placed in the completion string 714 or riser (e.g., in a subsea well), and is biased closed and held open by a remote signal. When the remote signal is ceased, for example, due to failure of the well system above the valve 702, the valve 702 closes. Thereafter, the valve 702 is mechanically re-opened to recommence operation of the well.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Embodiments disclosed herein include:
A: A ball valve comprising: a valve body having inlet and outlet flow passageways connected by a valve chamber; a ball valve member mounted in said valve chamber for selective rotation between valve open and valve closed positions to control flow through the valve, the ball valve member comprising at least one pivot pin and a mount for a control arm; and at least one control arm comprising a slot configured to accept at least one of a control arm bushing, the at least one pivot pin, and combinations thereof, wherein the at least one control arm is mounted to the ball valve member.
B: A ball mechanism comprising: a ball valve member having inlet and outlet flow passageways, the ball valve member comprising at least one pivot pin and a mount for a control arm, wherein the ball valve member controls flow through the passageways upon selective rotation between open passageway and closed passageway positions; and at least one control arm comprising a slot configured to accept at least one of a control arm bushing, the at least one pivot pin, and combinations thereof, wherein the at least one control arm is mounted to the ball valve member.
C: A method of opening or closing a ball valve, the method comprising: applying an axial load on the control arm of a ball valve comprising: a valve body having inlet and outlet flow passageways connected by a valve chamber; a ball valve member mounted in said valve chamber for selective rotation between valve open and valve closed positions to control flow through the valve, the ball valve member comprising at least one pivot pin and at least one mount for at least one control arm; and at least one control arm comprising at least one slot configured to accept at least one of a control arm bushing, the at least one pivot pin, and combinations thereof, wherein the at least one control arm is mounted to the ball valve member.

Each of embodiments A, B, and C may have one or more of the following additional elements in any combination: Element 1: wherein upon application of an axial load on the control arm to the open or close the ball valve, the axial load on the control arm is transferred to at least one of a control arm bushing, the at least one pivot pin on the ball valve member, and combinations thereof. Element 2: further comprising a seat in the valve body around each of said passageways adjacent to the ball valve member. Element 3: further comprising at least one control arm bushing, mounted on said at least one pivot pin. Element 4: wherein the at least one control arm bushing is a square or rectangular bushing machined to slide in the at least one slot of the at least one control arm. Element 5: further comprising a second control arm with at least one slot, a second pivot pin, and a second mount on the ball valve member for the second control arm. Element 6: wherein the second control arm and second pivot pin are located on the opposite side of the ball valve member from the at least one pivot pin and at least one control arm. Element 7: wherein the at least one slot is milled into the control arm. Element 8: wherein the at least one pivot pin is circular in shape. Element 9: wherein the ball valve has increased initial rotation of the ball valve member for the same axial travel of the at least one control arm compared to a ball valve where the at least one pivot pin is on the at least one control arm, the at least one slot is on the ball valve member, and the at least one pivot pin slides in the at least one slot of the ball valve member. Element 10: wherein the mount for the at least one control arm on the ball valve member comprises at least one mounting pivot pin around which the at least one control arm pivots. Element 11: wherein the at least one control arm comprises a second slot for receiving the at least one mounting pivot pin of the ball valve member. Element 12: further comprising a valve body having inlet and outlet flow passageways connected by a valve chamber, wherein the ball valve member is mounted in the valve chamber.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

1. A ball valve comprising:
a valve body having inlet and outlet flow passageways connected by a valve chamber;
a ball valve member mounted in said valve chamber for selective rotation between valve open and valve closed positions to control flow through the valve, the ball valve member comprising at least one pivot pin and a mount for a control arm; and
at least one control arm comprising a slot configured to accept at least one of a control arm bushing, the at least one pivot pin, and combinations thereof, wherein the at least one control arm is mounted to the ball valve member.

2. The ball valve of claim 1, wherein upon application of an axial load on the control arm to the open or close the ball valve, the axial load on the control arm is configured to transfer to at least one of a control arm bushing, the at least one pivot pin on the ball valve member, and combinations thereof.

3. The ball valve of claim 1, further comprising a seat in the valve body around each of said passageways adjacent to the ball valve member, and further comprising at least one control arm bushing, mounted on said at least one pivot pin wherein the at least one control arm bushing is a square or rectangular bushing machined to slide in the at least one slot of the at least one control arm.

4. (canceled)

5. (canceled)

6. The ball valve of claim 1, further comprising a second control arm with at least one slot, a second pivot pin, and a second mount on the ball valve member for the second control arm, wherein the second control arm and second pivot pin are located on the opposite side of the ball valve member from the at least one pivot pin and at least one control arm.

7. (canceled)

8. (canceled)

9. (canceled)

10. The ball valve of claim 1, wherein the ball valve has increased initial rotation of the ball valve member for the same axial travel of the at least one control arm compared to a ball valve where the at least one pivot pin is on the at least one control arm, the at least one slot is on the ball valve member, and the at least one pivot pin is configured to slide in the at least one slot of the ball valve member.

11. The ball valve of claim 1, wherein the mount for the at least one control arm on the ball valve member comprises at least one mounting pivot pin around which the at least one control arm pivots, and further wherein the at least one control arm comprises a second slot for receiving the at least one mounting pivot pin of the ball valve member.

12. (canceled)

13. A ball mechanism comprising:
a ball valve member having inlet and outlet flow passageways, the ball valve member comprising at least one pivot pin and a mount for a control arm, wherein the ball valve member controls flow through the passageways upon selective rotation between open passageway and closed passageway positions; and
at least one control arm comprising a slot configured to accept at least one of a control arm bushing, the at least one pivot pin, and combinations thereof, wherein the at least one control arm is mounted to the ball valve member.

14. The ball mechanism of claim 13, wherein upon application of an axial load on the at least one control arm to rotate the ball valve member, the axial load on the at least one control arm is configured to transfer to at least one of a control arm bushing, the at least one pivot pin on the ball valve member, and combinations thereof.

15. The ball mechanism of claim 13, further comprising a valve body having inlet and outlet flow passageways connected by a valve chamber, wherein the ball valve member is mounted in the valve chamber.

16. The ball mechanism of claim 13, further comprising at least one control arm bushing, mounted on said at least one pivot pin.

17. The ball mechanism of claim 16, wherein the at least one control arm bushing is a square or rectangular bushing machined to slide in the at least one slot of the at least one control arm.

18. The ball mechanism of claim 13, further comprising a second control arm with at least one slot, a second pivot pin, and a second mount on the ball valve member for the second control arm.

19. The ball mechanism of claim 18, wherein the second control arm and second pivot pin are located on the opposite side of the ball valve member from the at least one pivot pin and at least one control arm.

20. The ball mechanism of claim 13, wherein the at least one slot is milled into the at least one control arm.

21. The ball mechanism of claim 13, wherein the at least one pivot pin is circular in shape.

22. The ball mechanism of claim 13, wherein the valve has increased initial rotation of the ball valve member for the same axial travel of the control arm compared to a ball valve where the pivot pin is on the control arm, the slot is on the ball valve member, and the pivot pin is configured to slide in the slot of the ball valve member.

23. The ball mechanism of claim 13, wherein the mount for the at least one control arm on the ball valve member comprises at least one mounting pivot pin around which the at least one control arm pivots.

24. The ball mechanism of claim 23, wherein the at least one control arm comprises a second slot for receiving the at least one mounting pivot pin of the ball valve member.

25. A method of opening or closing a ball valve, the method comprising:
applying an axial load on the control arm of a ball valve comprising:
a valve body having inlet and outlet flow passageways connected by a valve chamber;
a ball valve member mounted in said valve chamber for selective rotation between valve open and valve closed positions to control flow through the valve, the ball valve member comprising at least one pivot pin and at least one mount for at least one control arm; and
at least one control arm comprising at least one slot configured to accept at least one of a control arm bushing, the at least one pivot pin, and combinations thereof, wherein the at least one control arm is mounted to the ball valve member.

26. The method of claim 25, wherein upon application of an axial load on the at least one control arm to open or close the ball valve, the axial load on the at least one control arm is transferred to at least one of at least one control arm bushing, the at least one pivot pin on the ball valve member, and combinations thereof.

27. (canceled)

28. (canceled)

29. (canceled)

30. (canceled)

31. (canceled)

32. (canceled)

33. The method of claim 25, wherein the ball valve has increased initial rotation of the ball valve member for the same axial travel of the at least one control arm compared to a ball valve where the at least one pivot pin is on the at least one control arm, the at least one slot is on the ball valve member, and the at least one pivot pin slides in the at least one slot of the ball valve member.

34. (canceled)

35. (canceled)
